(19) United States
(12) Patent Application Publication
(10) Pub. No.: US 2020/0325977 A1
(43) Pub. Date: Oct. 15, 2020

(54) APPARATUS FOR ELECTRICAL DEVICE AND RELATED METHOD

(71) Applicant: INOLECT, LLC, Baton Rouge, LA (US)

(72) Inventors: Chester Greer, Baton Rouge, LA (US); Robert Schilling, JR., Livingston, LA (US); Brian Chassaniol, Denham Springs, LA (US); Lonnie Barr, Zachary, LA (US)

(21) Appl. No.: 16/826,536

(22) Filed: Mar. 23, 2020

Related U.S. Application Data
(60) Provisional application No. 62/833,170, filed on Apr. 12, 2019.

(51) Int. Cl. F16H 57/025; F16H 21/10; H02K 7/116; H02K 7/00

(52) U.S. Cl. CPC F16H 57/025; F16H 21/10; F16H 2057/02034; H02K 7/003; H02K 7/116

(57) ABSTRACT

Apparatuses for racking electrical devices such as circuit breakers and contactors are described in the present disclosure. A related method of operating such electrical devices using the one or more apparatuses is also described in the present disclosure.

### CROSS-REFERENCE TO RELATED APPLICATIONS

This application claims the benefit of U.S. Provisional Application No. 62/833,170, filed Apr. 12, 2019. The patent application identified above is incorporated here by reference in its entirety to provide continuity of disclosure.

### FIELD

The present disclosure relates to subject matter for operating an electrical device. More specifically, the present disclosure relates to subject matter including a force amplifying or levering mechanism for placing the electrical device in one or more operating positions, and related methods.

### BACKGROUND

Electrical devices, such as circuit breakers and contractors, are often utilized to establish electrical circuits. From time to time, maintenance requirements (e.g., repair, replacement, load control, etc.) necessitate racking operations to disconnect (“rack out”) and connect (“rack in”) such electrical devices. During these operations, electrical circuits may short-circuit and produce a dangerous condition known as an arc flash.

Arc-flash occurs when an electric current passes through air when insulation or isolation between electrified conductors is insufficient to withstand the applied voltage. During an arc flash, temperatures can rapidly escalate causing conductors to melt, vaporize, and expand to several thousand times their normal volume, which may generate a pressure wave carrying molten metal capable of hitting surfaces with a large force (e.g., forces of several hundred pounds per square inch). As a result, maintenance personnel need to possess equipment and methods for safely performing racking operations to prevent injury or death from an arc-flash.

Maintenance personnel have utilized personal protective equipment (PPE) to reduce exposure to potential arc flash hazards. However, PPE, without more, often does not eliminate the risk of injury or death because personnel are still in close proximity to the electrical device during racking operations. To further mitigate the likelihood of injury or death from arc flash, personnel should perform racking operations a safe distance from the circuit breaker.

Thus, a need exists for an apparatus and method capable of permitting remote operation of electrical equipment (e.g., remote operation of a circuit breaker or contactor) at safe distance from the electrical equipment.

### SUMMARY

In general, the present disclosure provides an apparatus including a gearbox comprising an input shaft and an output shaft in which a longitudinal axis of the input shaft of the gearbox is substantially orthogonal to a longitudinal axis of the output shaft of the gearbox; a support member supporting the gearbox; one or more attachment members extending from the support member and configured to permit the apparatus to be removably secured to a surface of an electrical device; and a lever operatively engaged to the output shaft of the gearbox wherein the lever is configured to operatively engage the electrical device so as to pei mit removal or installation of the electrical device.

One or more aspects include the apparatus of the preceding paragraph in which the input shaft of the gearbox is arranged and configured to engage a motor that is operatively connected to a controller that is configured to direct the motion of the motor.

One or more aspects include the apparatus of any preceding paragraph in which the one or more attachment members comprise a first attachment member comprising one or more connectors, and a second attachment member comprising one or more connectors.

One or more aspects include the apparatus of any preceding paragraph in which the one or more connectors comprise one or more magnets configured to engage the surface of the electrical device so as to secure the apparatus to the surface of the electrical device.

One or more aspects include the apparatus of any preceding paragraph in which one or more attachment members comprise a first attachment member supporting at least one first connector that is a magnet, and a second attachment member having a body that defines one or more apertures, wherein the one or more apertures are configured to engage one or more respective pins that are secured to the surface of the electrical device.

One or more aspects include the apparatus of any preceding paragraph in which the apparatus further includes a mounting member extending from the one or more attachment members and configured to mount the apparatus to the surface of the electrical device.

The present disclosure provides an apparatus including a motor comprising an output shaft; a controller operatively connected to the motor and configured to direct the motion of the motor; a support member supporting the motor and the controller; one or more attachment members extending from the support member and configured to secure the apparatus to a surface of an electrical device; and a lever operatively engaged to the output shaft of the motor, wherein the lever is configured to operatively engage the electrical device so as to permit removal or installation of the electrical device.

One or more aspects include the apparatus of the preceding paragraph further including a control station operatively connected to the controller and configured to operate the controller.

One or more aspects include the apparatus of any preceding paragraph in the one or more attachment members comprise a first attachment member comprising one or more connectors; and a second attachment member comprising one or more connectors.

One or more aspects include the apparatus of any preceding paragraph in which the one or more connectors comprise one or more magnets configured to engage the surface of the electrical device so as to secure the apparatus to the surface of the electrical device.

One or more aspects include the apparatus of any preceding paragraph in which the one or more attachment members comprise a first attachment member supporting at least one first connector that is a magnet; and a second attachment member having a body that defines one or more apertures, wherein the one or more apertures are configured to engage one or more respective pins that are secured to the surface of the electrical device.

One or more aspects include the apparatus of any preceding paragraph further including a mounting member extending from the surface of the one or more attachment members and configured to mount the apparatus to the surface of the electrical device.

One or more aspects include the apparatus of the preceding paragraph in which the motor and controller are secured to the support member.

In another aspect the present disclosure provides a method including (A) securing the apparatus of any preceding paragraph to the surface of the electrical device; (B) engaging the lever of the apparatus with the electrical device so as to allow removal or installation of the electrical device; and (C) operating the output shaft of the apparatus so as to cause the lever to remove or install the electrical device.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE DRAWING(S)

For a detailed description of the preferred embodiments of the disclosed embodiments, reference will now be made to the accompanying drawing(s) in which:

FIG. 1 illustrates a front view of an embodiment of an apparatus in accordance with certain aspects of the subject matter described herein.

FIG. 2 illustrates a back view of the apparatus of FIG. 1.

FIG. 3 illustrates a top view of the apparatus of FIG. 1.

FIG. 4 illustrates a bottom view of the apparatus of FIG. 1.

FIG. 5 illustrates a side view of the apparatus of FIG. 1.

FIG. 6 illustrates a side view of the apparatus of FIG. 1.

FIG. 7 illustrates an exploded view of the apparatus of FIG. 1.

FIG. 8 illustrates a front view of an embodiment of an apparatus in accordance with certain aspects of the subject matter described herein.

FIG. 9 illustrates a back view of the apparatus of FIG. 8.

FIG. 10 illustrates a top view of the apparatus of FIG. 8.

FIG. 11 illustrates a bottom view of the apparatus of FIG. 8.

FIG. 12 illustrates a side view of the apparatus of FIG. 8.

FIG. 13 illustrates a side view of the apparatus of FIG. 8.

FIG. 14 illustrates an exploded view of the apparatus of FIG. 8.

FIG. 15 illustrates a front view of an embodiment of an apparatus in accordance with certain aspects of the subject matter described herein.

FIG. 16 illustrates a back view of the apparatus of FIG. 15.

FIG. 17 illustrates a top view of the apparatus of FIG. 15.

FIG. 18 illustrates a bottom view of the apparatus of FIG. 15.

FIG. 19 illustrates a side view of the apparatus of FIG. 15.

FIG. 20 illustrates a side view of the apparatus of FIG. 15.

FIG. 21 illustrates an exploded view of the apparatus of FIG. 15.

FIG. 22 illustrates a front view of an embodiment of an apparatus in accordance with certain aspects of the subject matter described herein.

FIG. 23 illustrates a back view of the apparatus of FIG. 22.

FIG. 24 illustrates a top view of the apparatus of FIG. 22.

FIG. 25 illustrates a bottom view of the apparatus of FIG. 22.

FIG. 26 illustrates a side view of the apparatus of FIG. 22.

FIG. 27 illustrates a side view of the apparatus of FIG. 22.

FIG. 28 illustrates a side view of the apparatus of FIG. 22.

FIG. 29 illustrates an exploded view of the apparatus of FIG. 22.

FIG. 30 illustrates a front view of an embodiment of an apparatus in accordance with certain aspects of the subject matter described herein.

FIG. 31 illustrates a back view of the apparatus of FIG. 30.

FIG. 32 illustrates a top view of the apparatus of FIG. 30.

FIG. 33 illustrates a bottom view of the apparatus of FIG. 30.

FIG. 34 illustrates a side view of the apparatus of FIG. 30.

FIG. 35 illustrates a side view of the apparatus of FIG. 30.

FIG. 36 illustrates an exploded view of the apparatus of FIG. 30.

FIG. 37 illustrates the apparatus of FIG. 1 in use with an electrical device.

FIG. 38 illustrates the apparatus of FIG. 1 in use with an electrical device and a remote racking device.

FIG. 39 illustrates the apparatus of FIG. 1 in use with an electrical device and a remote racking device.

FIG. 40 illustrates an apparatus in accordance with certain aspects of the subject matter described herein, in use with an electrical device and control station.

FIG. 41 illustrates a control station in use with the apparatus shown in FIG. 40.

FIG. 42 illustrates a hand control in use with the apparatus shown in FIG. 40.

FIG. 43 illustrates a hand control in use with the apparatus shown in FIG. 40.

While the claimed subject matter is susceptible to various modifications and alternative forms, the drawing(s) illustrate specific embodiments herein described in detail by way of example. It should be understood, however, that the description herein of specific embodiments is not intended to limit the claimed subject matter to the particular forms disclosed, but on the contrary, the intention is to cover all modifications, equivalents, and alternatives falling within the spirit and scope as defined by the appended claims.

### DEFINITIONS

To define more clearly the terms used in this disclosure, the following definitions are provided. Unless otherwise indicated, the following definitions are applicable to this disclosure. To the extent that any definition or usage provided by any document incorporated here by reference conflicts with the definition or usage provided herein, the definition or usage provided in this disclosure controls.

In this disclosure, features of the subject matter are described such that, within particular aspects, a combination of different features can be envisioned. For each and every aspect and each and every feature disclosed herein, all combinations that do not detrimentally affect the apparatuses, processes, or methods described herein are contemplated with or without explicit description of the particular combination. Additionally, unless explicitly recited otherwise, any aspect or feature disclosed herein can be combined to describe inventive apparatuses, processes, or methods consistent with the present disclosure.

In this disclosure, while apparatuses and methods are often described in terms of “comprising” various components or steps, the apparatuses and methods can also “consist essentially of” or “consist of” the various components or steps, unless stated otherwise. For example, one such apparatus consistent with certain aspects of the disclosed subject matter can comprise; alternatively, can consist essentially of; or alternatively, can consist of; a gearbox, a support member, one or more attachment members, and a lever.

The terms “a,” “an,” and “the” are intended to include plural alternatives, e.g., at least one, one or more, and one or more than one, unless otherwise specified. For example, the disclosure of “a connector” is meant to encompass one or combinations of more than one, connector, unless otherwise specified.

Directional phrases used herein relate to the orientation of the elements shown in the drawings and are not limiting upon the claims unless expressly recited therein. For example, left, right, top, bottom, clockwise, counterclockwise and derivatives thereof.

The term “racking” means any suitable manipulation of an electrical device, such as a circuit breaker or contactor, with respect to a housing structure (e.g., without limitation, switchgear cabinet). For example, “racking” a circuit breaker includes, without limitation, insertion/connection or removal/disconnection of the circuit breaker from a switchgear cabinet.

The term “coupled” means that the parts are joined together either directly or joined through one or more intermediate parts.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. Whether or not modified by the term “about,” the claims include equivalents to the quantities.

Embodiments disclosed herein can provide the components listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

All publications and patents mentioned herein are incorporated herein by reference for the purpose of describing and disclosing, for example, the constructs and methodologies that are described in the publications, which can be used in connection with the presently described subject matter.

### DETAILED DESCRIPTION

Illustrative aspects of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

### A. Apparatuses

Aspects of the subject matter disclosed herein are directed to one or more apparatuses for racking an electrical device such as a circuit breaker or contactor.

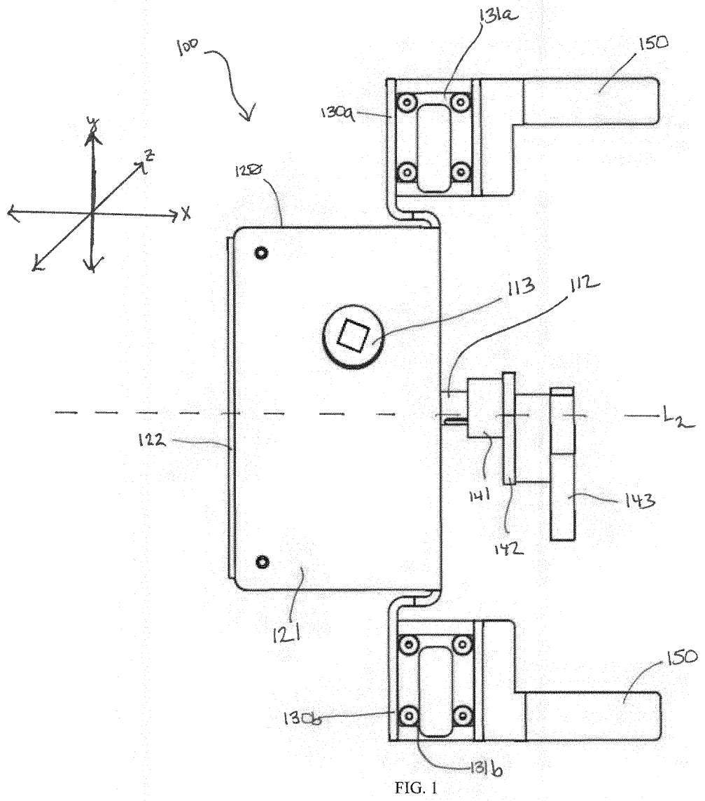

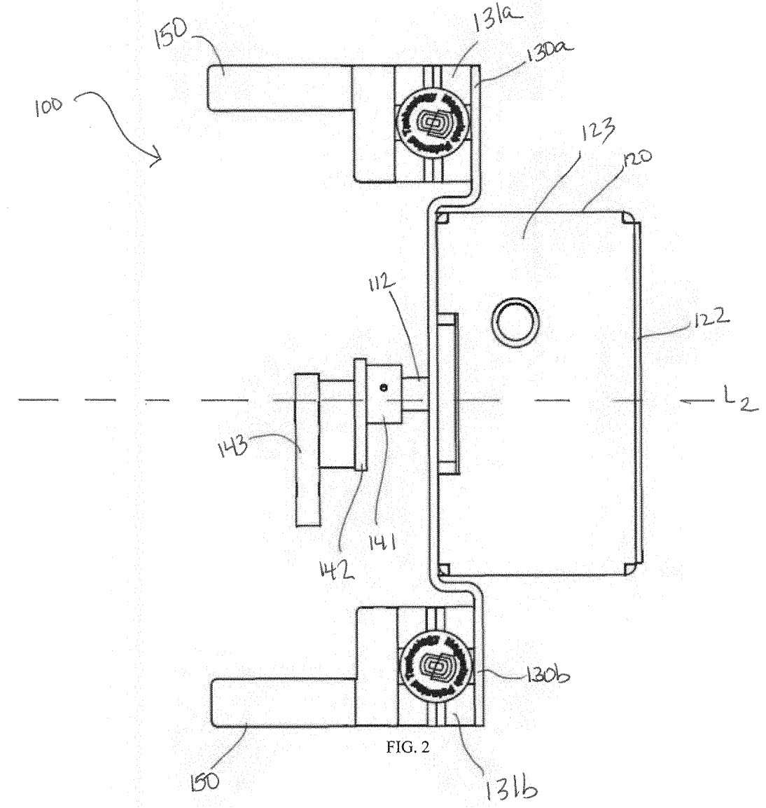

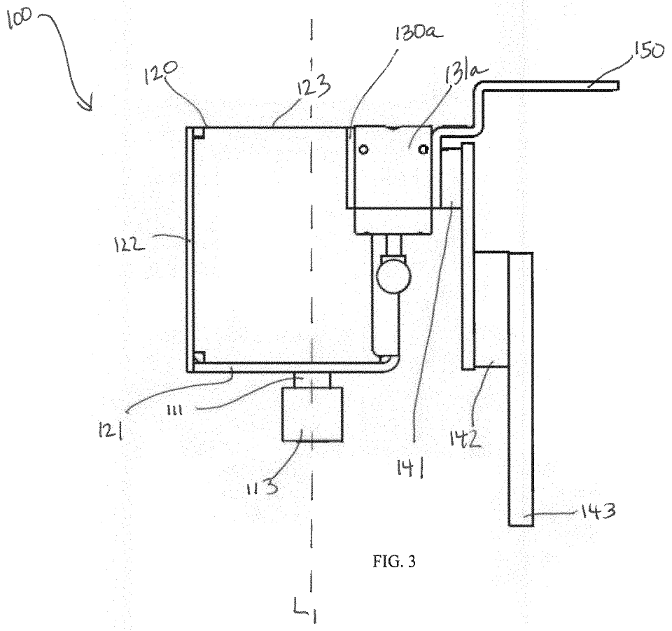

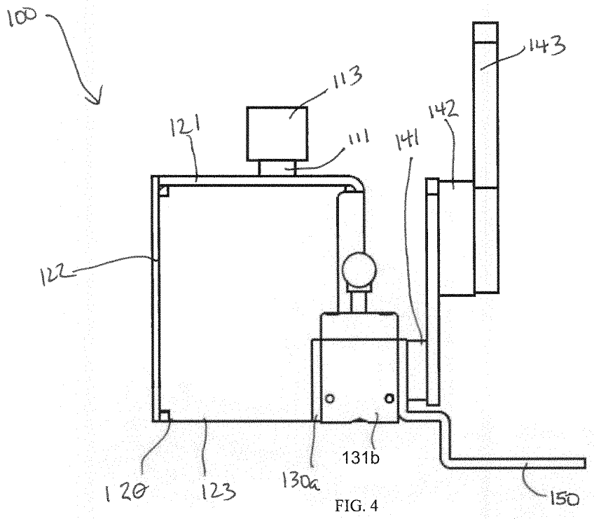

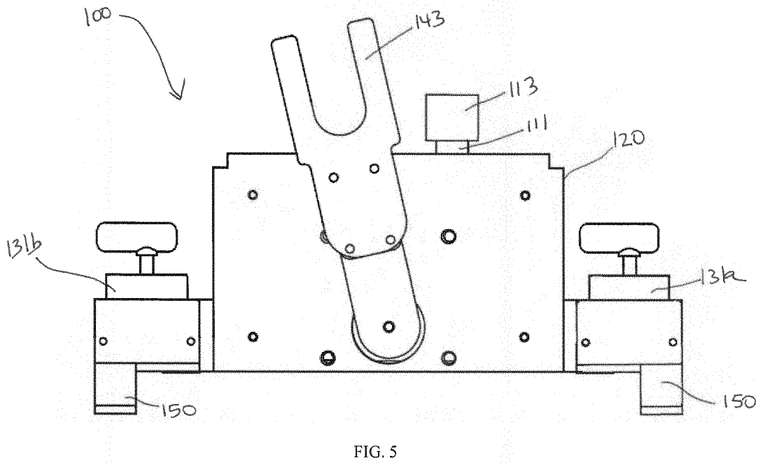

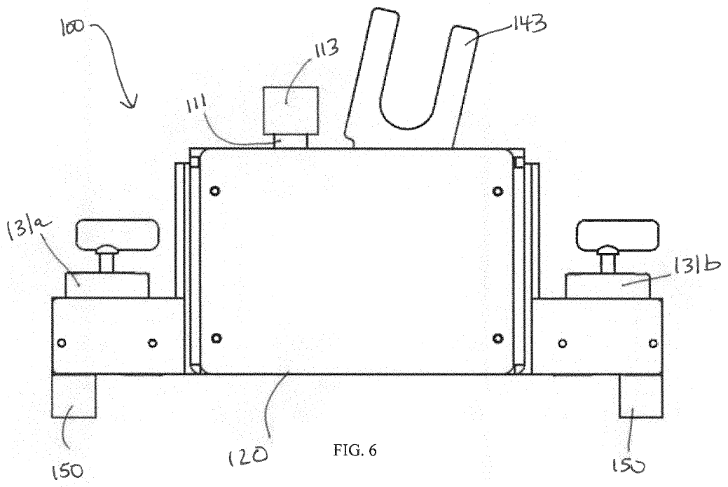

In an embodiment, the apparatus 100 comprises a gearbox 110, a support member 120, one or more attachment members 130, and a lever 140. The gearbox 110 comprises an input shaft 111 and an output shaft 112. The input shaft 111 of the gearbox 110 has a longitudinal axis L₁, and the output shaft 112 of the gearbox 110 has a longitudinal axis L₂. The longitudinal axis L₁ of the input shaft 111 may be substantially orthogonal to the longitudinal axis L₂ of the output shaft 112, e.g. a 90-degree gearbox, as illustrated in FIGS. 1-7.

In an aspect, the input shaft 111 of the gearbox 110 is arranged and configured to engage a motor that is operatively connected to a controller that is configured to direct the motion of the motor. For example, the input shaft 111 can include a coupling 113 that is sized and configured to mate with a connector operatively engaged with a shaft of the motor, such as a motor of a remote racking device, e.g., a remote racking device as disclosed in U.S. Pat. No. 8,604,369.

In an aspect, the output shaft 112 of the gearbox 110 is operatively engaged to the lever 140. The lever 140 is sized and configured to operatively engage the operating mechanism 220 of the electrical device 200 so as to permit removal or insertion of the electrical device when the input shaft 111 of the gearbox 110 is operated by the motor. For example, the lever 140 may comprise a member 142, such as a bar or an arm. The lever 140 may further comprise a coupling 143 that is configured to operatively engage the operation mechanism 220 of the electrical device 200. In certain aspects, the lever 140 may further comprise one or more spacers 141 to permit positioning of the lever 140 in a suitable location relative to the electrical device 200 when the apparatus 100 is secured to the surface of the electrical device 200.

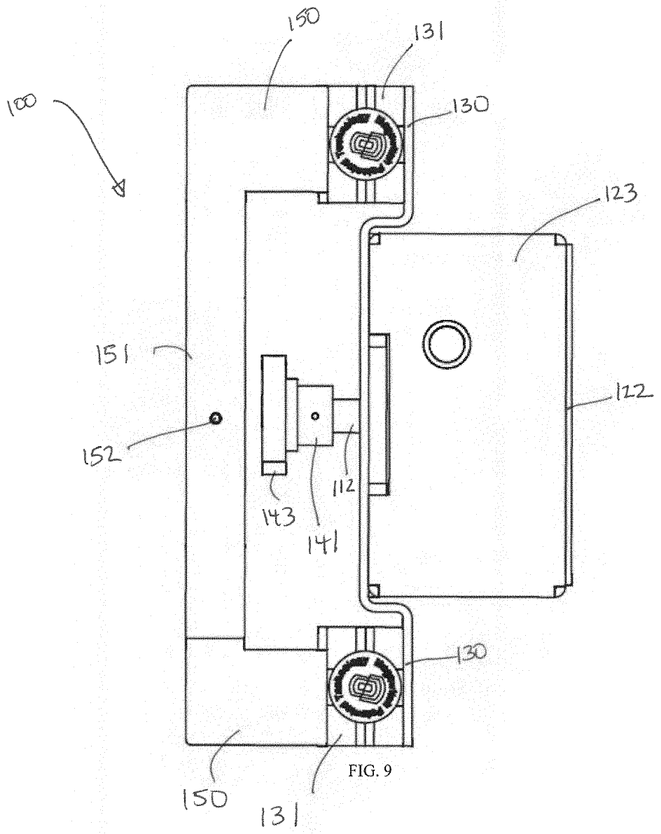

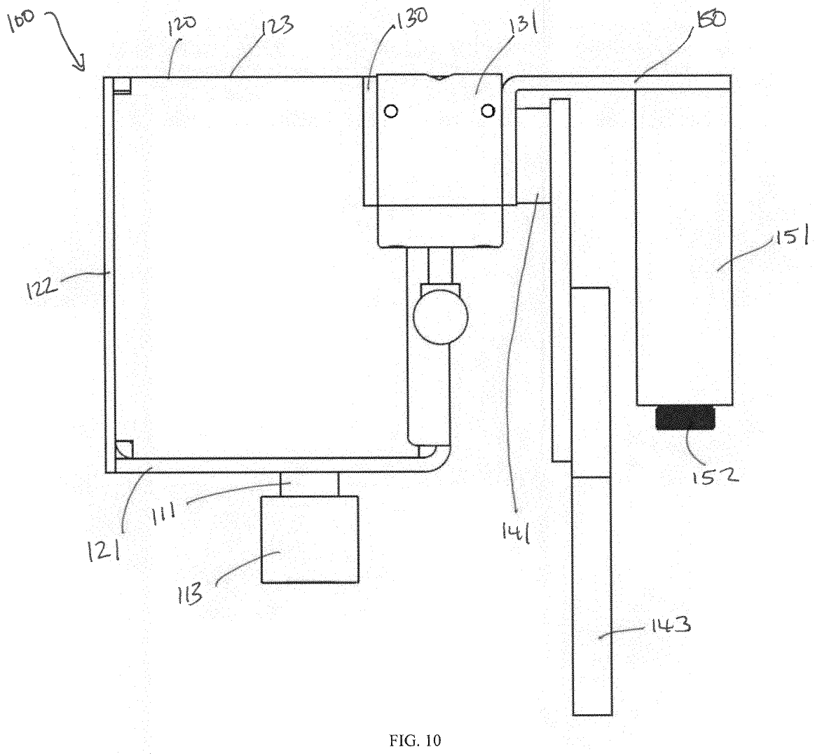

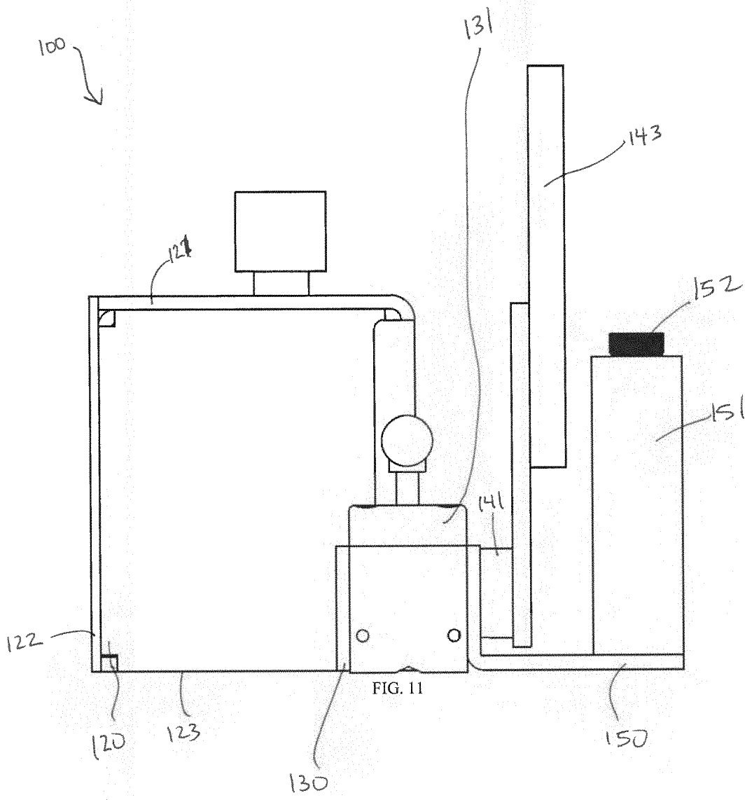

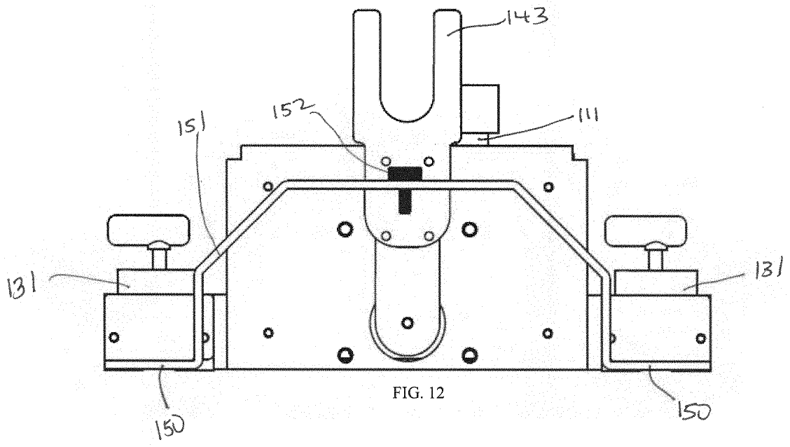

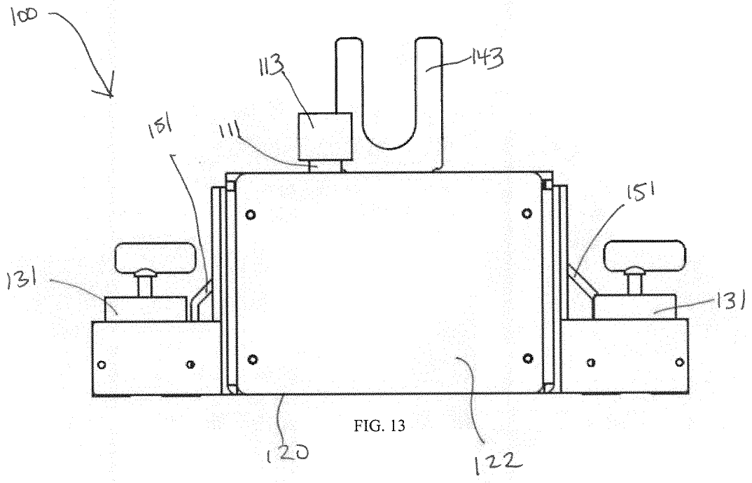

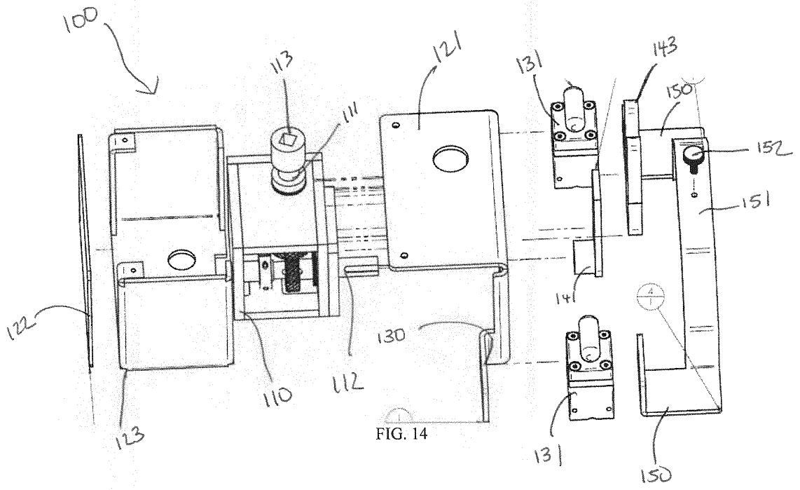

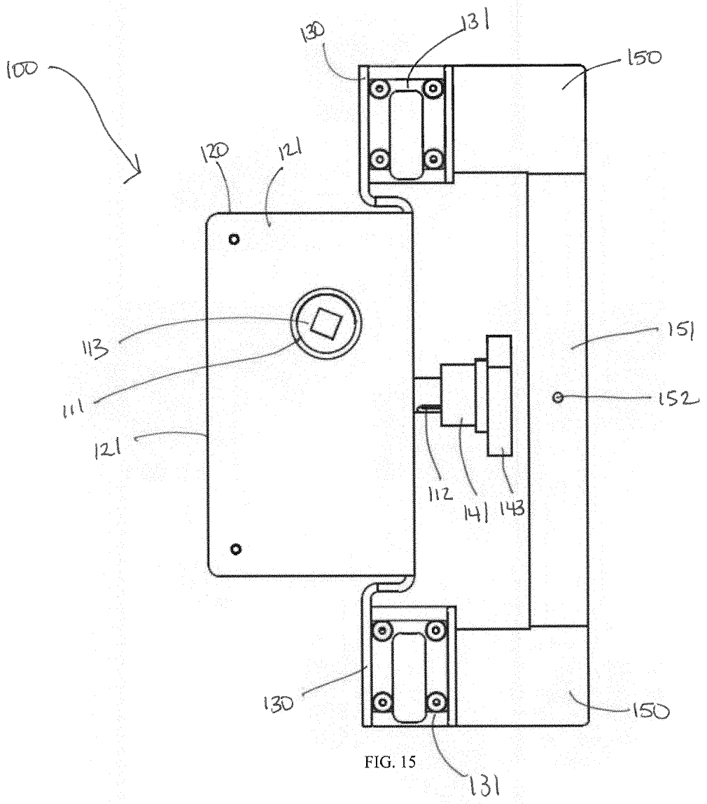

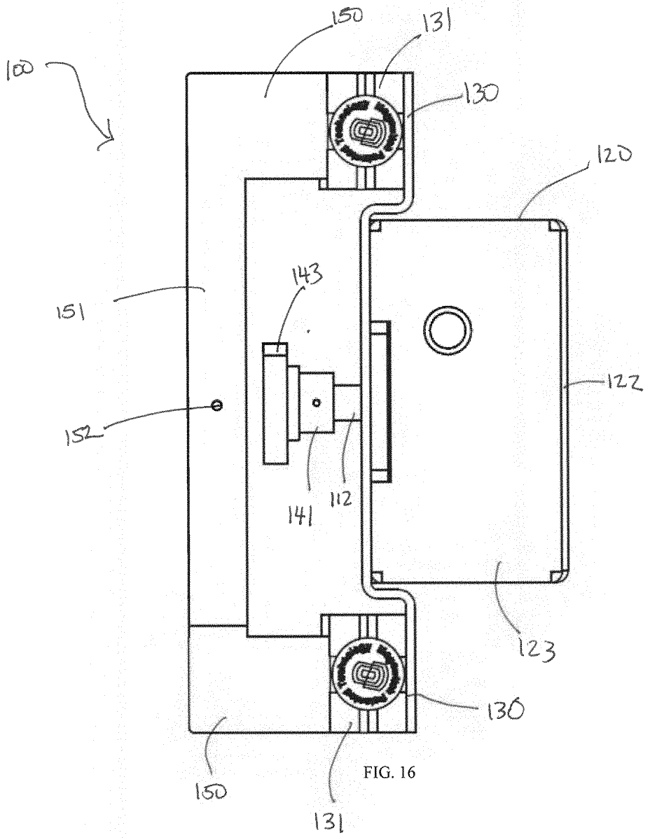

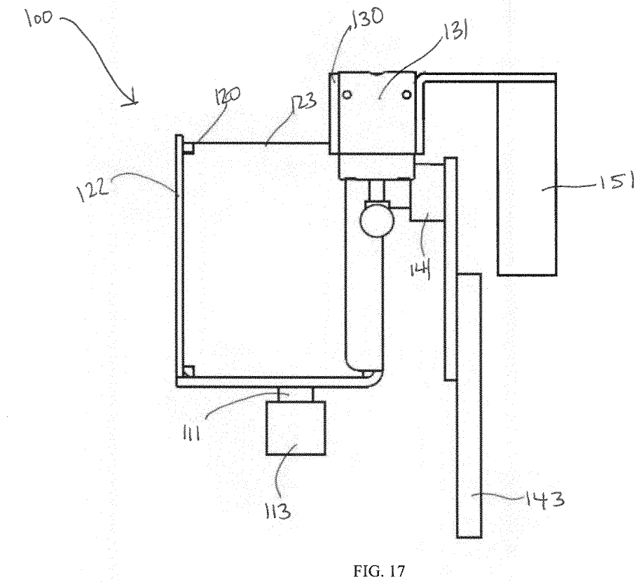

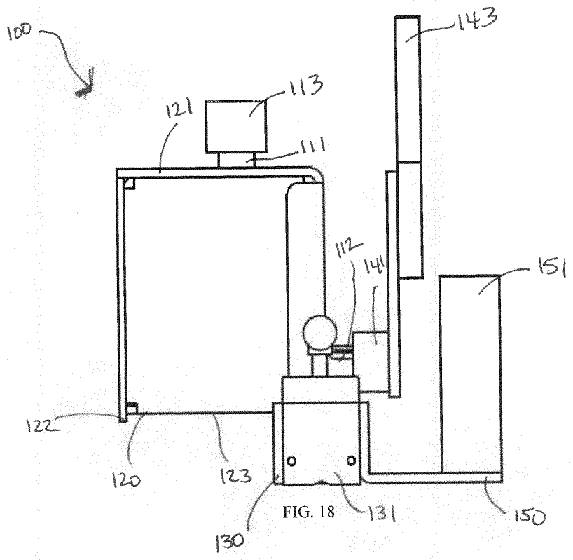

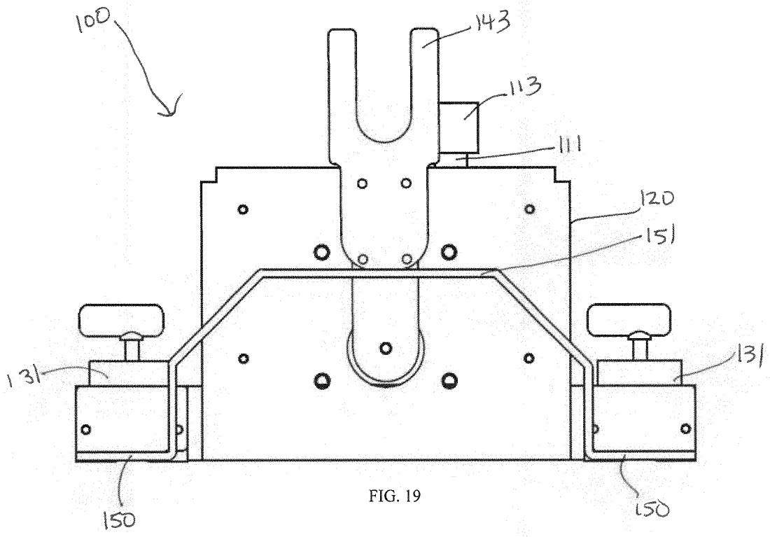

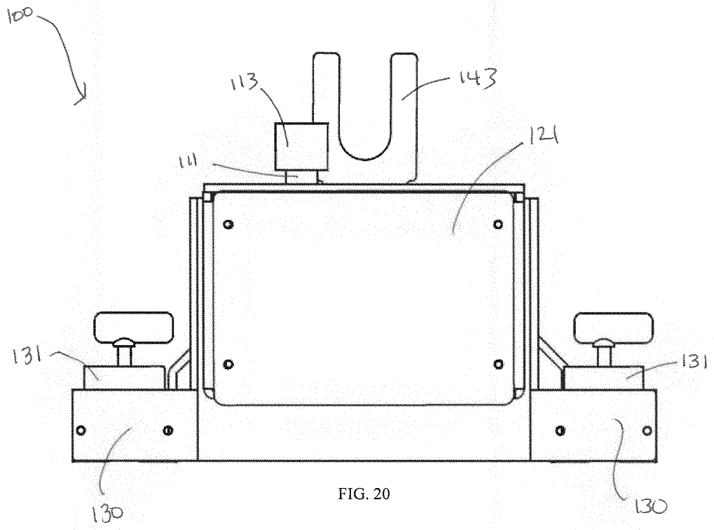

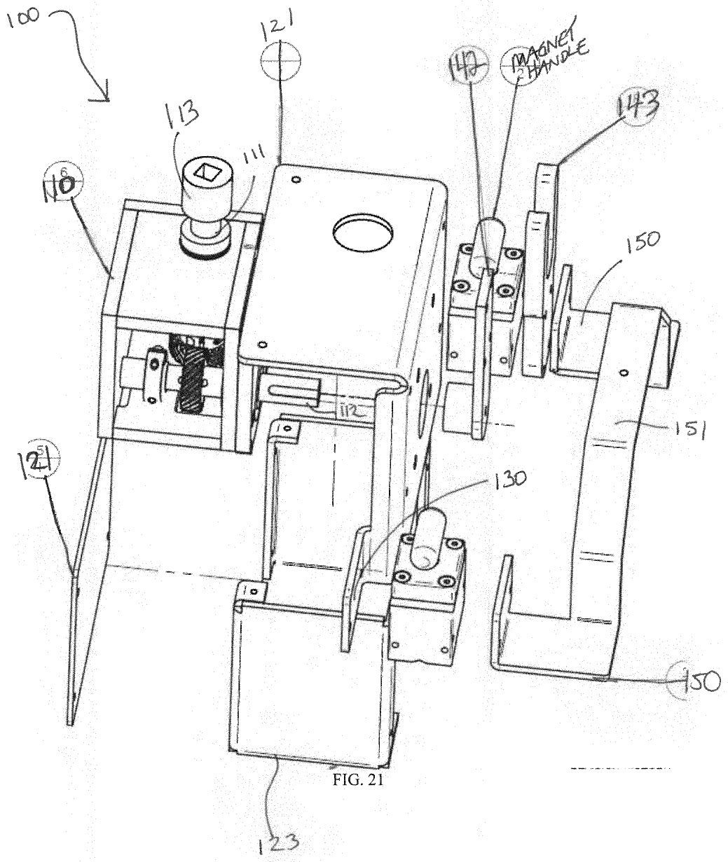

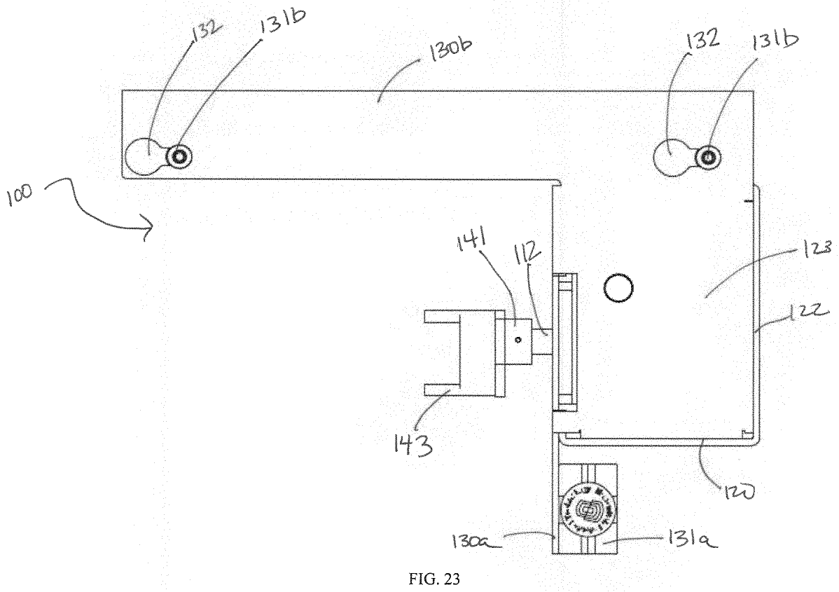

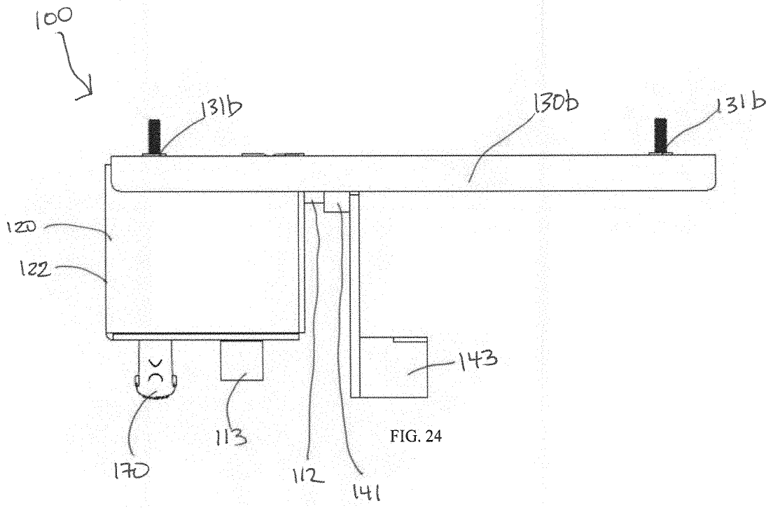

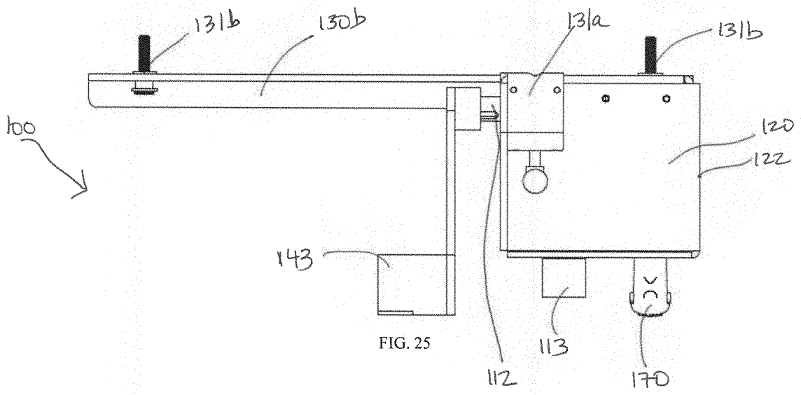

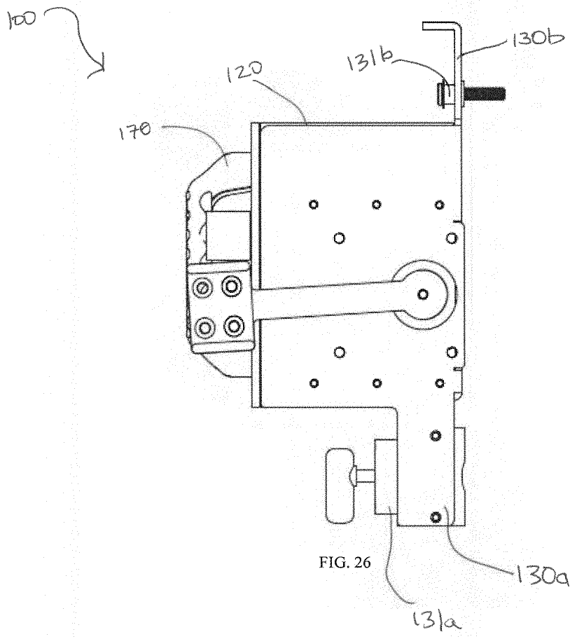

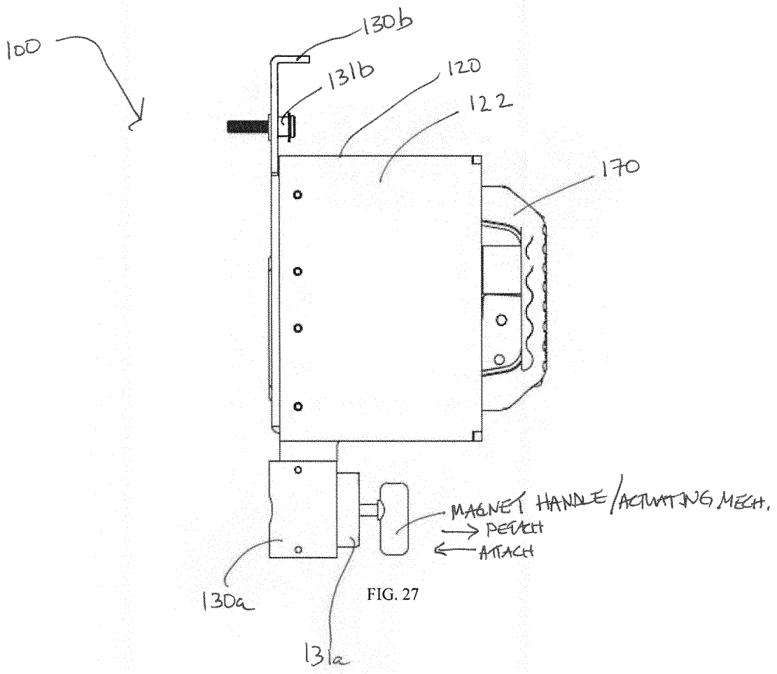

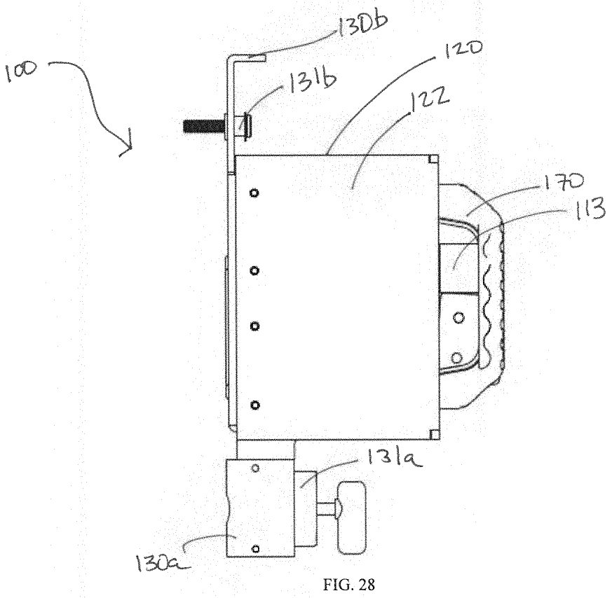

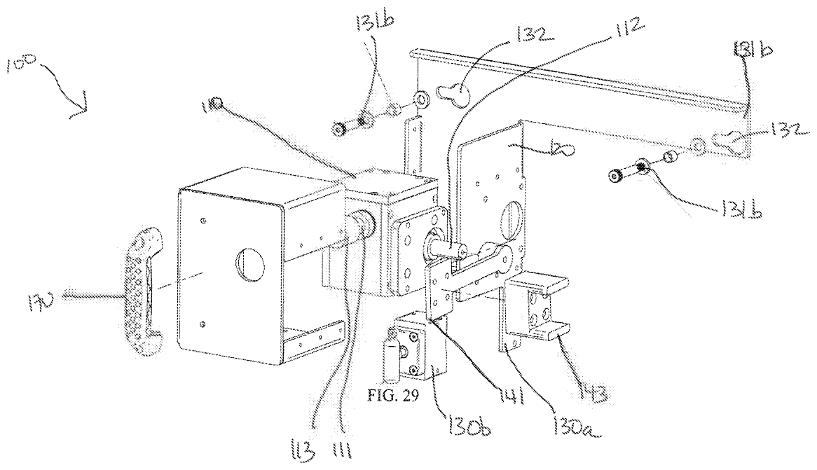

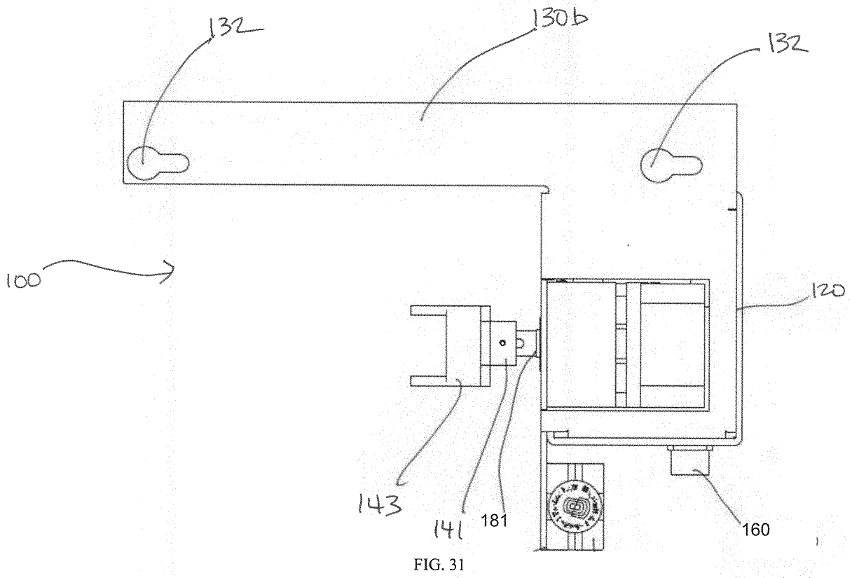

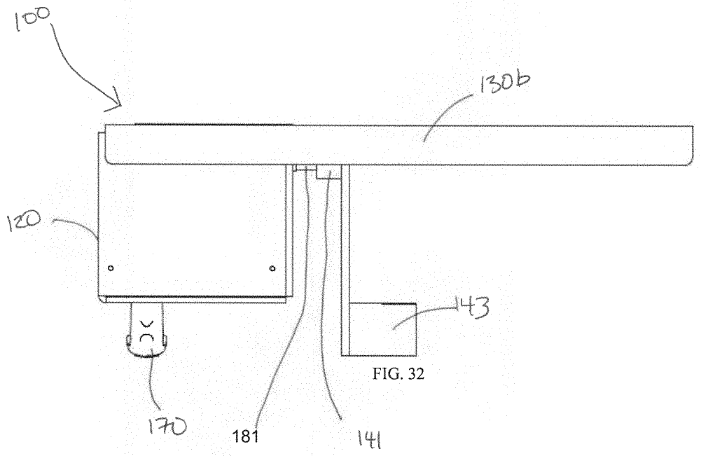

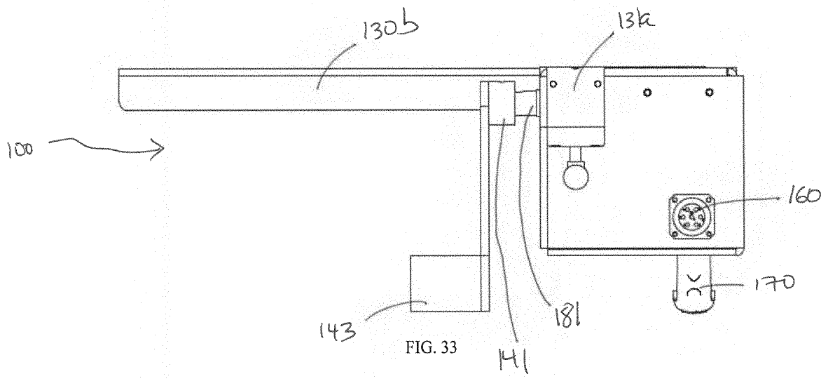

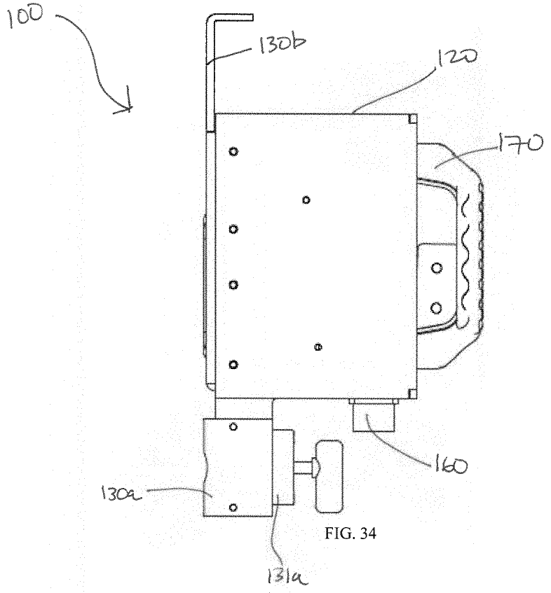

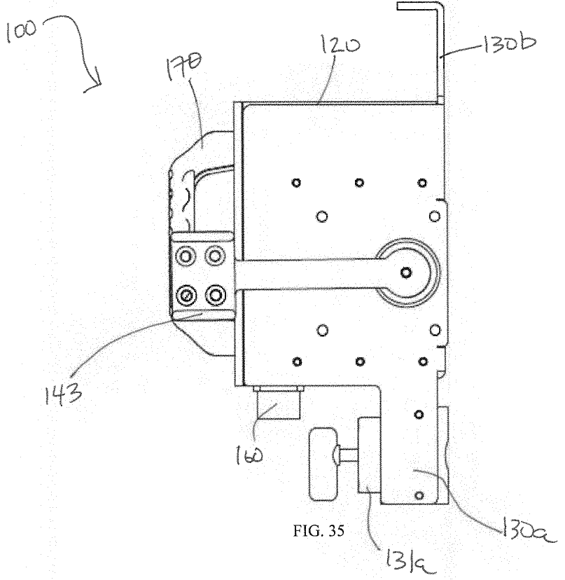

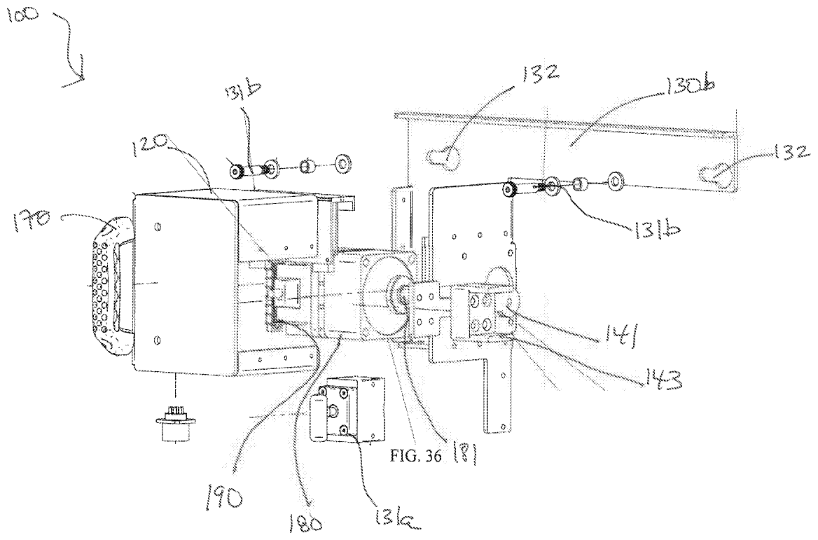

In an aspect, the support member 120 provides support for the gearbox 110. For example, as illustrated in FIGS. 1-36, the support member 120 may comprise one or more plates 121, 122, 123 that may form a housing that surrounds and supports the gearbox 110. The gearbox 110 may be secured to the support member 120 using one or more fasteners such as screws, nuts and bolts, and so forth.

In an aspect, the attachment member 130 extend from the support member 120. The attachment member 130 may comprise one or more connectors 131 to permit the apparatus 100 to be removably secured to a surface of the electrical device 200. Examples of suitable connectors may include, without limitation, magnets, screws, pins, suction cups, and so forth. The attachment member 130 may be integral with the support member 120 and extend from an end portion thereof. Alternatively, the attachment member 130 may be formed as a separate component, for example as a bracket or plate, that is secured to the support member 120 using one or more fasteners, such as screws, nuts and bolts, and so forth.

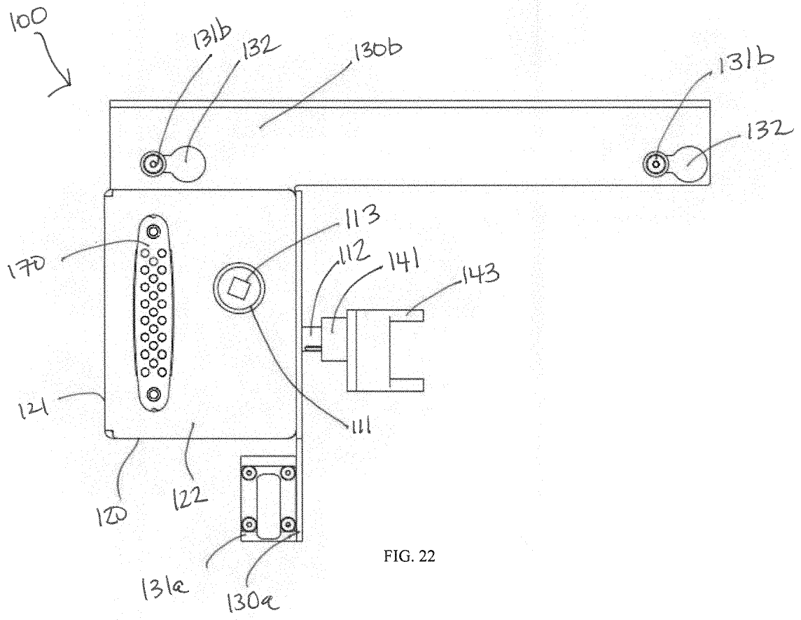

In certain aspects, the one or more attachment members may comprise a first attachment member 130a and a second attachment member 130b. Each attachment member 130a, 130b supports a respective connector 131. For example, as illustrated in FIGS. 1-7, the apparatus 100 may comprise a first attachment member 130a and a second attachment member 130a, each attachment member 130a, 130b supporting at least one connector 131a, 131b that is a magnet. Each magnet may be provided with an actuator, such as a handle, that is configured to move the magnet towards or away from the surface of the electrical device when the handle is operated. As another example, as illustrated in FIGS. 22-29, the one or more attachment members 130 may comprise a first attachment member 130a supporting at least one first connector 131a that is a magnet, and a second attachment member 130b having a body that defines one or more apertures 132, such as slots, wherein the one or more apertures 132 are configured to engage one or more connectors 131b (e.g., pins) that are secured to the surface of the electrical device 200. Examples of suitable magnets include, without limitation, magnets available from Magswitch Technology, Inc., with an address of 1355 Horizon Avenue, Lafayette, Colo. 80026, such as MagSquare magnets.

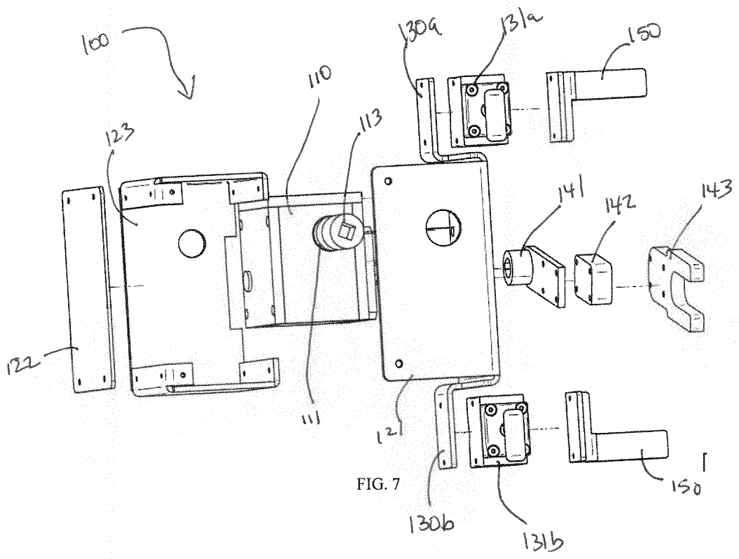

In an aspect, the apparatus 100 may further comprise one or more mounting members 150 supported by or extending from the one or more attachment members 130. The mounting member may be sized and configured to interface with the surface of the electrical device 200 thereby causing the panel 210 of a circuit breaker 200 to remain in a closed position. The mounting member 150 may be secured to an attachment member 130 using fasteners, for example as illustrated in FIG. 7.

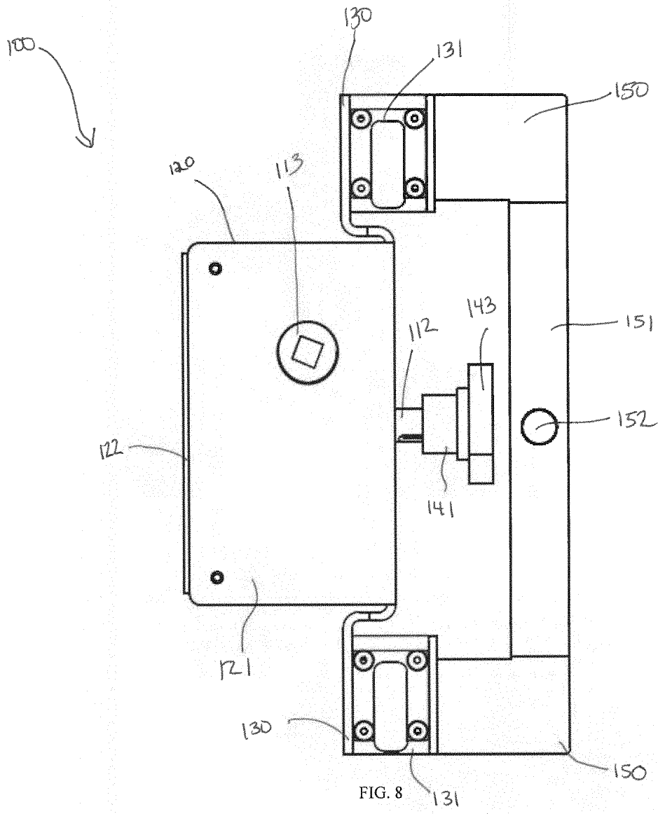

In certain aspects, as illustrated in FIGS. 8-14, the mounting member 150 may comprise a first mounting member and a second mounting member, each extending from the attachment member, and further comprising a third mounting member 151 secured to an end portion of the first mounting member and the second mounting member. The mounting member 150 can further comprises at least one fastener to allow the apparatus 100 to be secured to the surface of the electrical device 200. For example, as illustrated in FIGS. 8-14, the one or more mounting members 150 includes a fastener 152 such as a thumbscrew.

In certain aspects, the apparatus 100 may further comprise a handle 170 to permit an operator to align and position the apparatus with a surface of the electrical device 200. The handle 170 can be secured to the support member using a fastener such as a screw, nut and bolt, and so forth.

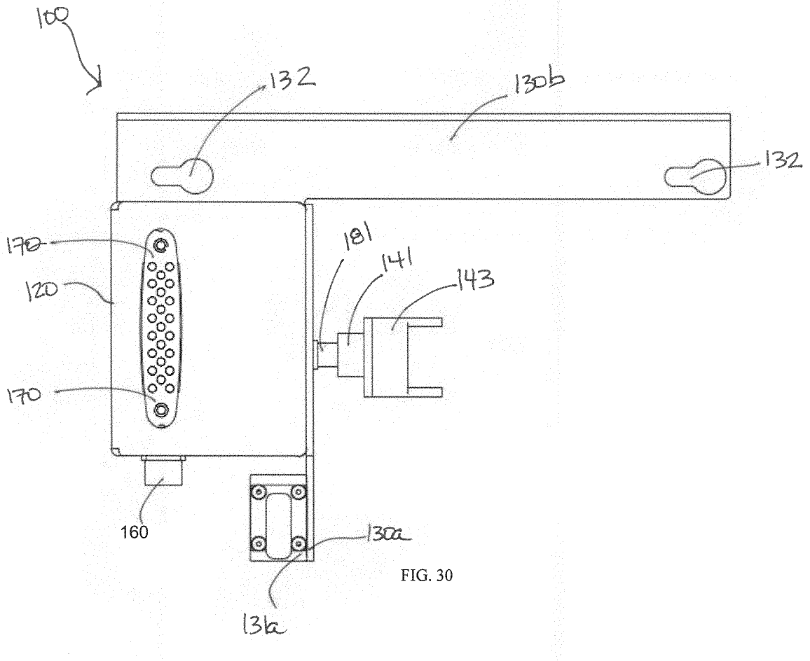

In another embodiment of the apparatus 100, as illustrated in FIGS. 30-36, instead of a gearbox, the apparatus 100 described herein may comprise a motor 180 having an output shaft 181, and a controller 190, each of which is supported by the support member 120. For example, the support member 120 may comprise one or more plates 121, 122, 123 that foitii a housing surrounding and supporting the motor 180 and controller 190. The motor 180 and controller 190 can each be supported by the support member 120, for example, by forming a housing that surrounds the motor 180 and controller 190, and/or securing the motor 180 and the controller 190 to the support member 120 using one or more fasteners. The controller 190 is in operative communication with a control station 400. For example, the apparatus 100 may further comprise a port 160 operatively connected to the controller thereby permitting the controller 190 to be in operative communication with the control station 400. The port 160 of the apparatus 100 may also be secured to the support member 120 and may be connected to the control station 400 using a cable 420. The control station 400 may further comprise a hand control 410 that is operatively connected to the control station 400 through a cable 430 to permit the operator to be remote from the electrical device 200 and control station 400. Alternatively, instead of a cable connection between the controller 190 and control station 400, the control station 400 may be configured to communicate wirelessly with the controller 190. In this manner, the control station 400 permits operate the controller 190 of the apparatus 100 to direct the motion of the motor 180 and its output shaft 181 in a clockwise or counter clockwise direction causing movement of the lever 140 to remove or install the electrical device 200, while an operator is remote to the electrical device 200. Examples of suitable motors includes, without limitation, BLH5100KC-100″ in 100 W (⅛ HP) BLH Series) (Brushless DC Motor Speed Control Systems) available from Oriental Motor U.S.A. Corp.

The one or more apparatuses 100 described herein may be constructed from any sufficiently strong and resilient material to allow such apparatus to be repeatedly used to operative an electrical device. Suitable materials of constructions include, without limitation, metals such as aluminum, mild steel, stainless steel, nylon, nyoil, and any combination of two or more of the foregoing.

### B. Methods

Aspects of the subject matter disclosed herein are also directed to one or more methods for removing or installing an electrical device such as a circuit breaker or contactor. In an aspect the method comprises (A) securing the apparatus described herein to the surface of the electrical device; (B) engaging the lever of the apparatus with the electrical device so as to allow removal or installation of the electrical device; and (C) operating the apparatus so as to cause the lever to remove or install the electrical device.

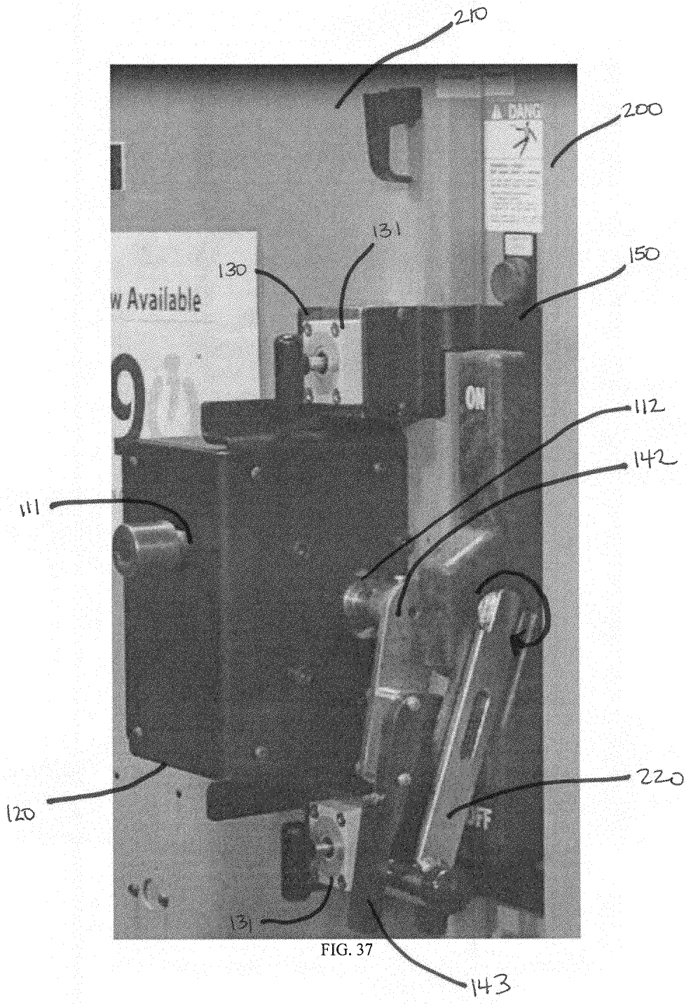

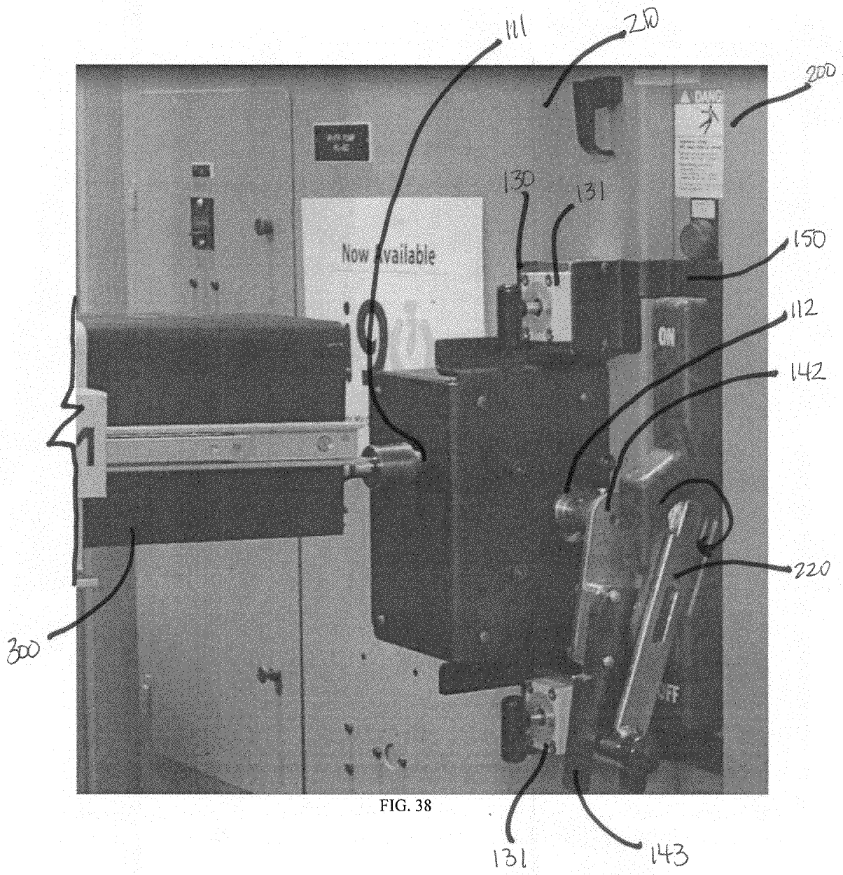

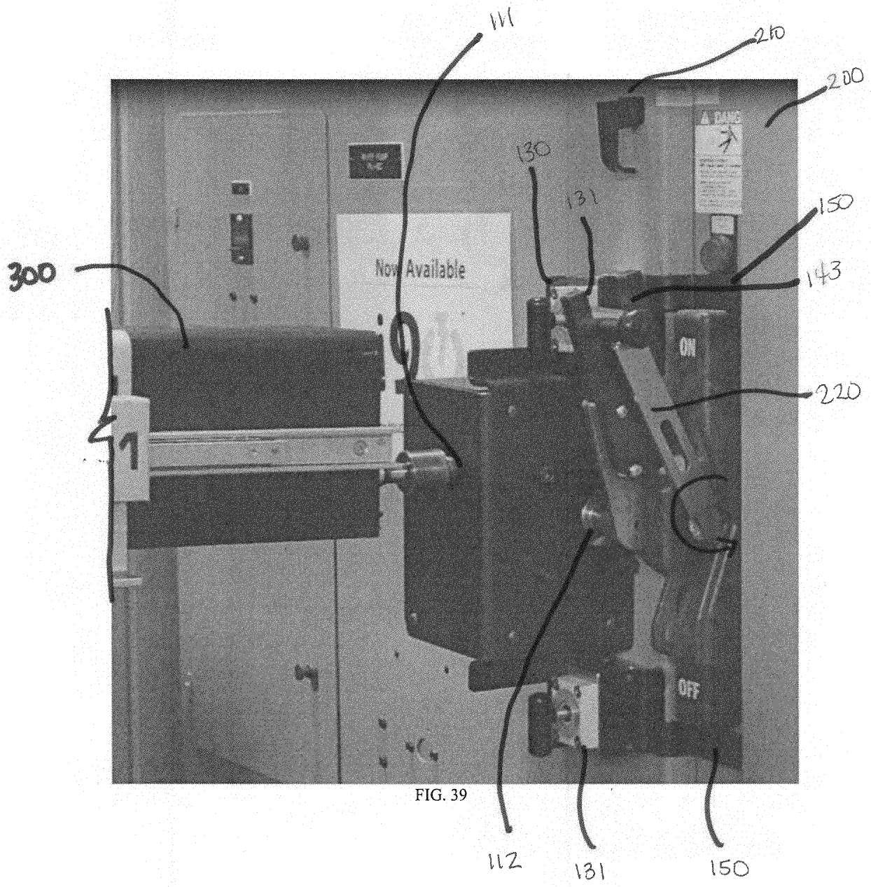

With reference to FIGS. 37-39, in operation, an apparatus 100 in accordance with certain aspects disclosed herein, is removably secured to a surface of an electrical device 200. For example, as shown in FIG. 37, the apparatus 100 is removably secured to a panel 210 of the electrical device 200 using connectors 131 that are magnets. The lever of the apparatus is coupled to the operating mechanism of the electrical device. Each mounting member 150 of the apparatus 100 is sized and configured to interface with the electrical device so as to maintain the panel in a closed position. The electrical device is shown in the removed or disconnected position in FIG. 37. As illustrated in FIG. 38, a remote racking device 300 (e.g., a remote racking device as disclosed in U.S. Pat. No. 8,604,369) operatively engages the coupling 113 of the input shaft 111 of the gearbox 110. The motor of the remote racking device 300 is operated to rotate the input shaft 111 of the gearbox, which in turn rotates the output shaft 112 of the gearbox 110 so as to cause the lever 140 to operate the operating mechanism 220 of the electrical device 200 and thus insert or connect the electrical device 200. Similarly, the motor of the remote racking device 300 may be operated to rotate the input shaft 111 of the gearbox, which in turn rotates the output shaft 112 of the gearbox 110 so as to cause the lever to move the operating mechanism 220 of the electrical device 200 and thus remove or disconnect the electrical device 200.

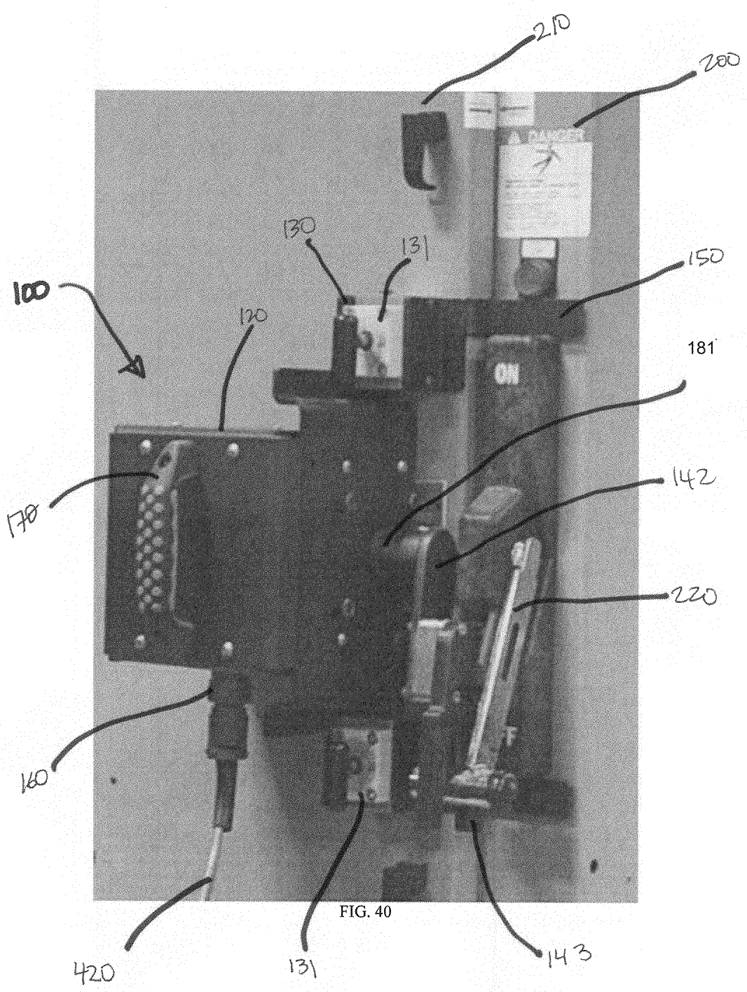

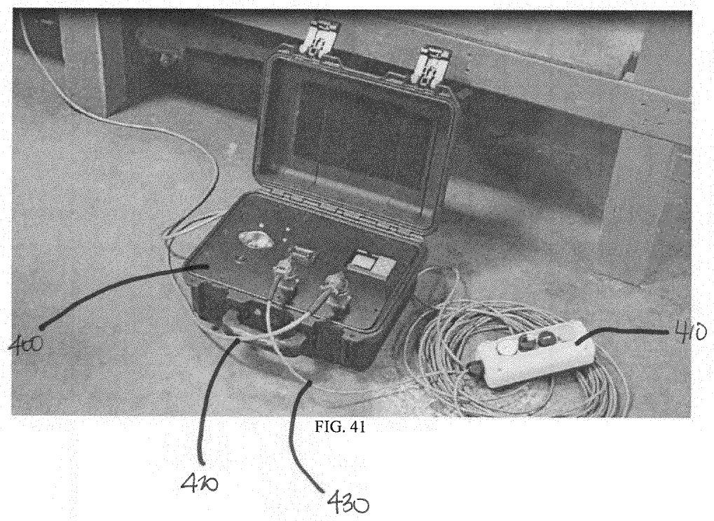

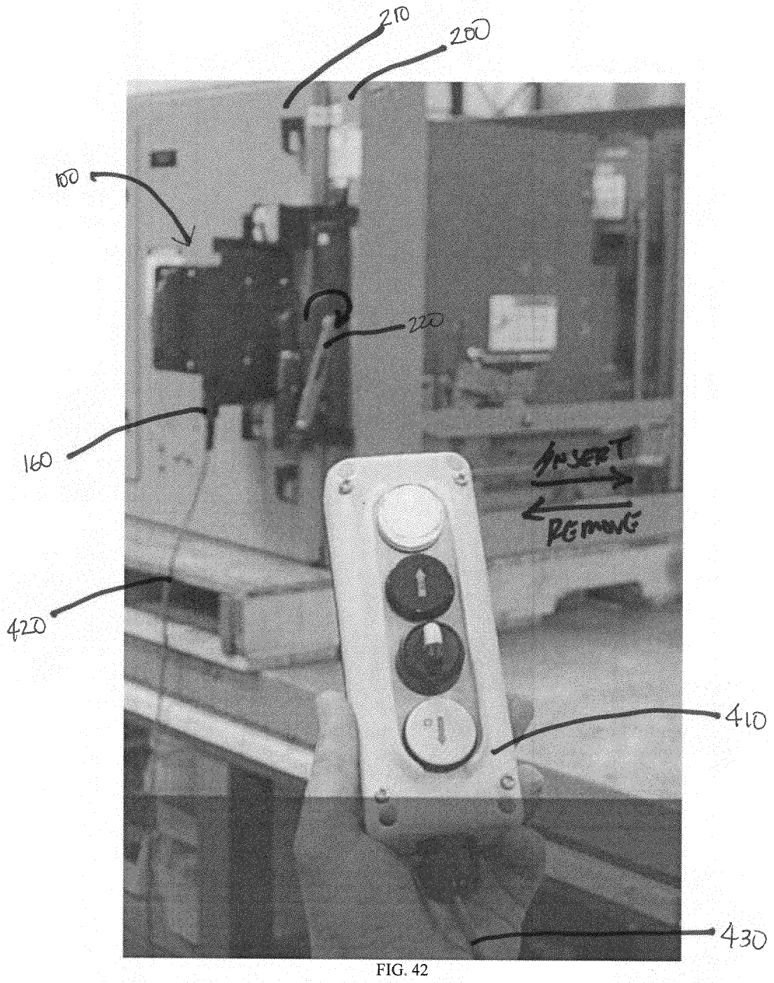

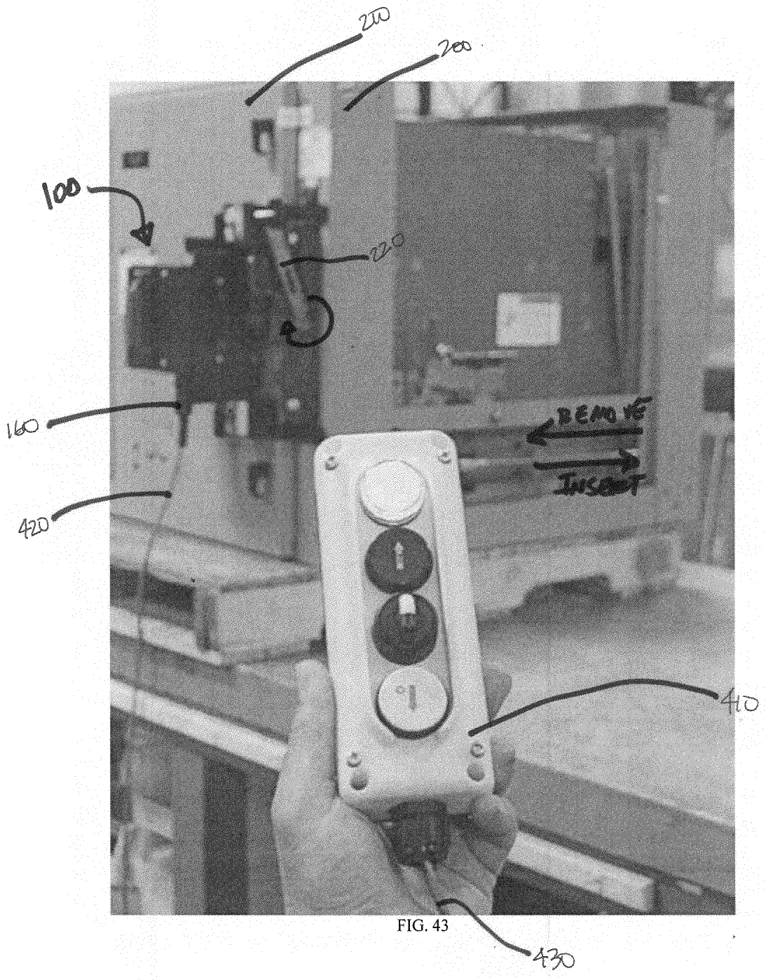

FIGS. 40-43 depict an apparatus 100 having a motor 180 and controller 190, each of which is supported by the support member 120. The apparatus 100 is removably secured to a panel 210 of the electrical device 200 using connectors 131 that are magnets. The lever 140 of the apparatus 100 is coupled to the operating mechanism 220 of the electrical device 200. Each mounting member 150 of the apparatus 100 is sized and configured to interface with the electrical device 220 so as to maintain the panel 210 in a closed position. The electrical device 200 is shown in the removed or disconnected position in FIG. 40. As illustrated in FIG. 41, a control station 400 is operatively connected to the port 160 of the apparatus using a cable 420. The control station 400 is also operatively connected to a hand control 410. The operator utilizes the hand control 410 to cause the control station 400 to send a signal to the controller 190 of the apparatus 100. The controller 190 of the apparatus 100 directs the motion of the motor 180, which rotates the output shaft 112 of the motor 180 so as to cause the lever 140 to operate the operating mechanism 220 of the electrical device 200 and thus install or connect the electrical device 200. Similarly, the motor 180 may be operated to rotate the output shaft 181 of the motor 180 so as to cause the lever 140 to operate the operating mechanism 220 of the electrical device 200 and thus remove or disconnect the electrical device 200.

The subject matter is described above with reference to numerous aspects and specific examples. Many variations will suggest themselves to those skilled in the art in light of the above detailed description. All such obvious variations are within the full intended scope of the appended claims. Other aspects of the subject matter disclosed herein can include, but are not limited to, the following (aspects are described as “comprising” but, alternatively, can “consist essentially of”, or “consist of”):

Aspect 1. An apparatus comprising:
(a) a gearbox comprising an input shaft and an output shaft, wherein a longitudinal axis of the input shaft of the gearbox is substantially orthogonal to a longitudinal axis of the output shaft of the gearbox;
(b) a support member supporting the gearbox;
(c) one or more attachment members extending from the support member and configured to permit the apparatus to be removably secured to a surface of an electrical device; and
(d) a lever operatively engaged to the output shaft of the gearbox, wherein the lever is configured to operatively engage the electrical device so as to permit removal or installation of the electrical device.

Aspect 2. The apparatus defined in Aspect 1, wherein the input shaft of the gearbox is arranged and configured to engage a motor that is operatively connected to a controller that is configured to direct the motion of the motor.

Aspect 3. The apparatus defined in any one of Aspects 1-2, wherein the one or more attachment members comprise a first attachment member comprising one or more connectors; and a second attachment member comprising one or more connectors.

Aspect 4. The apparatus defined in any one of Aspects 1-3, wherein the one or more connectors comprise one or more magnets configured to engage the surface of the electrical device so as to secure the apparatus to the surface of the electrical device.

Aspect 5. The apparatus defined in any one of Aspects 1-4, wherein the one or more attachment members comprise a first attachment member supporting at least one first connector that is a magnet; a second attachment member having a body that defines one or more apertures, wherein the one or more apertures are configured to engage one or more respective pins that are secured to the surface of the electrical device.

Aspect 6. The apparatus defined in any one of Aspects 1-5 further comprising a mounting member extending from the one or more attachment members and configured to mount the apparatus to the surface of the electrical device.

Aspect 7. An apparatus comprising:
(a) a motor comprising an output shaft;
(b) a controller operatively connected to the motor and configured to direct the motion of the motor;
(c) a support member supporting the motor and the controller;
(d) one or more attachment members extending from the support member and configured to secure the apparatus to a surface of an electrical device; and
(e) a lever operatively engaged to the output shaft of the motor, wherein the lever is configured to operatively engage the electrical device so as to permit removal or installation of the electrical device.

Aspect 8. The apparatus defined in Aspect 7, wherein the one or more attachment members comprise a first attachment member comprising one or more connectors; and a second attachment member comprising one or more connectors.

Aspect 9. The apparatus defined in any one of Aspects 7-8, wherein the one or more connectors comprise one or more magnets configured to engage the surface of the electrical device so as to secure the apparatus to the surface of the electrical device.

Aspect 10. The apparatus defined in any one of Aspects 7-9, wherein the one or more attachment members comprise a first attachment member supporting at least one first connector that is a magnet; a second attachment member having a body that defines one or more apertures, wherein the one or more apertures are configured to engage one or more respective pins that are secured to the surface of the electrical device.

Aspect 11. The apparatus defined in any one of Aspects 7-10 further comprising a mounting member extending from the surface of the one or more attachment members and configured to mount the apparatus to the surface of the electrical device.

Aspect 12. The apparatus defined in any one of Aspects 7-11 further comprising a control station operatively connected to the controller and configured to operate the controller.

Aspect 13. The apparatus defined in any one of Aspects 7-12, wherein the motor and controller are secured to the support member.

Aspect 14. A method comprising:
(A) securing the apparatus of any of Aspects 1-13 to the surface of the electrical device;
(B) engaging the lever of the apparatus with the electrical device so as to allow removal or installation of the electrical device; and
(C) operating the output shaft of the apparatus so as to cause the lever to remove or install the electrical device.

The following is a table showing the reference numbers and a brief description of the same for use when referencing the Figures:

| Reference No. | Description |
|---|---|
| 100 | Apparatus |
| 110 | Gearbox |
| 111 | Input Shaft of Gearbox |
| 112 | Output Shaft of Gearbox |
| 113 | Coupling |
| 120 | Support Member |
| 121 | Plate |
| 122 | Plate |
| 123 | Plate |
| 130 | Attachment Member |
| 131 | Connector |
| 140 | Lever |
| 141 | Spacer |
| 142 | Bar |
| 143 | Coupling |
| 150, 151 | Mounting Member |
| 152 | Fastener |
| 160 | Port |
| 170 | Handle |
| 180 | Motor |
| 181 | Output Shaft of Motor |
| 190 | Controller |
| 200 | Electrical Device |
| 210 | Panel of Electrical Device |
| 220 | Operation Mechanism of Electrical Device |
| 300 | Remote Racking Device |
| 400 | Control station |
| 410 | Hand Control |
| 420 | Cable/Wire from Control station to Apparatus |
| 430 | Cable/Wire from Control station to Hand Control |
| L₁ | Longitudinal Axis of Input Shaft of Gearbox |
| L₂ | Longitudinal Axis of Output Shaft of Gearbox |

What is claimed is:

1. An apparatus comprising:
(a) a gearbox comprising an input shaft and an output shaft, wherein a longitudinal axis of the input shaft of the gearbox is substantially orthogonal to a longitudinal axis of the output shaft of the gearbox;
(b) a support member supporting the gearbox;
(c) one or more attachment members extending from the support member and configured to permit the apparatus to be removably secured to a surface of an electrical device; and
(d) a lever operatively engaged to the output shaft of the gearbox, wherein the lever is configured to operatively engage the electrical device so as to permit removal or installation of the electrical device.

2. The apparatus of claim 1, wherein the input shaft of the gearbox is arranged and configured to engage a motor that is operatively connected to a controller that is configured to direct the motion of the motor.

3. The apparatus of claim 2, wherein the one or more attachment members comprise:
a first attachment member comprising one or more connectors; and
a second attachment member comprising one or more connectors.

4. The apparatus of claim 3, wherein the one or more connectors comprise one or more magnets configured to engage the surface of the electrical device so as to secure the apparatus to the surface of the electrical device.

5. The apparatus of claim 2, wherein the one or more attachment members comprise:
a first attachment member supporting at least one first connector that is a magnet; and
a second attachment member having a body that defines one or more apertures, wherein the one or more apertures are configured to engage one or more respective pins that are secured to the surface of the electrical device.

6. The apparatus of claim 2 further comprising a mounting member extending from the one or more attachment members and configured to mount the apparatus to the surface of the electrical device. An apparatus comprising:
(a) a motor comprising an output shaft;
(b) a controller operatively connected to the motor and configured to direct the motion of the motor;
(c) a support member supporting the motor and the controller;
(d) one or more attachment members extending from the support member and configured to secure the apparatus to a surface of an electrical device; and
(e) a lever operatively engaged to the output shaft of the motor, wherein the lever is configured to operatively engage the electrical device so as to permit removal or installation of the electrical device.

8. The apparatus of claim 7, wherein the motor and controller are secured to the support member.

9. The apparatus of claim 7, further comprising a control station operatively connected to the controller and configured to operate the controller.

10. The apparatus of claim 9, wherein the one or more attachment members comprise:
a first attachment member comprising one or more connectors; and
a second attachment member comprising one or more connectors.

11. The apparatus of claim 10, wherein the one or more connectors comprise one or more magnets configured to engage the surface of the electrical device so as to secure the apparatus to the surface of the electrical device.

12. The apparatus of claim 9, wherein the one or more attachment members comprise:
a first attachment member supporting at least one first connector that is a magnet; and
a second attachment member having a body that defines one or more apertures, wherein the one or more apertures are configured to engage one or more respective pins that are secured to the surface of the electrical device.

13. The apparatus of claim 9 further comprising a mounting member extending from the surface of the one or more attachment members and configured to mount the apparatus to the surface of the electrical device.

14. A method comprising:
(A) securing the apparatus of claim 1 to the surface of the electrical device;
(B) engaging the lever of the apparatus with the electrical device so as to allow removal or installation of the electrical device; and
(C) operating the output shaft of the apparatus so as to cause the lever to remove or install the electrical device.

15. A method comprising:
(A) securing the apparatus of claim 7 to the surface of the electrical device;
(B) engaging the lever of the apparatus with the electrical device so as to allow removal or installation of the electrical device; and
(C) operating the output shaft of the apparatus so as to cause the lever to remove or install the electrical device.
